(19) United States
(12) Patent Application Publication
(10) Pub. No.: US 2006/0020537 A1
(43) Pub. Date: Jan. 26, 2006

(54) Internet business transactions approach model system

(76) Inventors: Yun-Ming Chang, Ping-Don (TW); Ming-Hsien Chen, Taipei (TW); Po-Jih Wang, Taipei (TW)

Correspondence Address: ANTHONY R. BARKUME, 20 GATEWAY LANE, MANORVILLE, NY, 11949, US

(21) Appl. No.: 10/897,540

(22) Filed: Jul. 23, 2004

(51) Int. Cl. G06Q 40/00

(52) U.S. Cl. 705/37

(57) ABSTRACT

The present invention relates to an internet business transactions approach model system, which uses an internet electrical business platform to proceed the following steps. Generate the member chain group, being able to recommend son members by existed members, and generate the member chain group by above linkage of members and their son members. Account the requirement information from members to take the internet transaction. The internet electrical business platform is able to use the trading information interactive interface program (living shopping messenger) to send out the goods requirement information to venders that are collected interactively from all the members of the member chain group. And, the members also is able to send out the goods requirement information via this internet electrical business platform, and the internet electrical business platform will merge and match the information of buyers and venders for required goods and estimated prices, to negotiate with venders with large quantities for a group of members or lead a individual buyer to match with a suitable vender. Finally, take the approach feedback mechanism, feedback money to members by a percentage of revenue from the internet electrical business platform.

### FIELD OF THE INVENTION

The present invention relates to an electrical business trading model that belongs to the trading web sites of electrical business, especially for collecting members by the internet electrical business platform, and purchasing large amounts of goods by members' requirements information to get lower prices, to match the trading of buyers and venders, and to provide members a feedback mechanism.

### BACKGROUND OF THE INVENTION

The evolution of the electrical business on the internet technology is more and more popular, and grows up by times with the increase of population on internet. Even industry also begins to implement the business web site for providing electrical business service.

The internet transactions of electrical business provide consumers another shopping approach. The advantage of internet transaction is to save lots of time for consumers, and easier to compare the goods prices than the traditional market. Consumers are very easy to get the prices of target goods to decide the transaction by entering the key words of these goods on the web sites.

In general shopping web sites, it is not only to provide copious web contents but also to provide a simple shopping cart system and a secure on-line trading mechanism or they cannot satisfy the shopping willing of consumers.

Such as the traditional market, the mechanisms of “quantity-decide-price” and “bargain in the traditional market” still remain in the internet transactions. Therefore, a normal, individual, independent consumer cannot get the best price of the target goods because of the small required quantity. There is no better promotion without large requirement quantity.

So, some consumers will try to pull down the prices by substitutive purchase via internet. Substitutive purchase via the internet means, one person is able to negotiate with venders directly, and then these persons publish this information onto the internet to accumulate a large quantity of these goods from lots of individual consumers, purchase by a cheaper price of these goods with a large quantity, and deliver to each consumer.

But above mechanism cannot be real-time managed in a database, so the performance of substitutive purchase via internet is not preferred and the data will be lost frequently. Secondly, the substitutive purchase via internet cannot obtain a preferential price from vender for lack of integration of a great quantity information from members. Furthermore, the bargain market on internet still lacks of active introducing media to engage the match of buyers and venders. To sum up, how to link buys and venders and to enhance the willing of individual consumers to join substitutive purchase via internet also are the focus of the present invention.

### SUMMARY OF THE INVENTION

An objective of the present invention is, due to the current business approaches play the roles of transferring and promoting commodities only, the cost of management and sales is so high as to break the balance of the market prices of commodities and the reasonable prices for consumers, and there is no any active leading media to engage the match of consumers and venders. This will make consumers select consumer approaches without any absolute loyalty. Based on the electrical business development, the associated purchase digital approach system of the present invention that uses the platform and technology of electrical business will be able to let approach sales decrease the approach cost very efficiently, let venders be able to control the shipping quantities of goods, and also let consumers be able to enhance the loyalty of approaches. To make venders, approach sales (the platform of the present invention), and consumers a three-win business model is the target of the present invention.

### BRIEF DESCRIPTION OF THE INVENTION

According to the present invention, an internet business transactions approach model system contains the following steps:

Providing an internet electrical business platform;

Creating a member chain group in master-slave relationship by using the internet electrical business platform;

Generating a trading information accounting system by the member chain group in master-slave relationship; and

Generating a feedback mechanism for the member chain by the member chain group in master-slave relationship.

In accordance with one aspect of the present invention, the member chain group in master-slave relationship uses the log-in action to create a new member; the member is allowed to pull in son members; the member chain group in master-slave relationship is generated by linking the members and their son members.

In accordance with one aspect of the present invention, the log-in action asks members for entering their personal information and assigns these members respective unique IDs; these IDs are used for master-slave linkage.

In accordance with one aspect of the present invention, the trading information accounting system is used for accounting the internet transaction logs of all the buyers and venders; by the trading information interactive accounting media program (living shopping messenger), the approach model will be able to send goods information to all the members of the member chain group; and the members are also able to send information requests for goods to this internet electrical business platform for integrating the information from buyers and venders. After integrating and accounting the required items and estimated prices of every member, the system of the present invention will base on the quantities and help to negotiate with goods venders for cheaper prices, or leads one individual buyer to match a suitable vender for a reasonable price, and purchases the order of these goods finally.

In accordance with one aspect of the present invention, the feedback mechanism of the member chain is an approach feedback mechanism. That is, the system is able to feedback money to members by a percentage of the revenue from the accounting trading records of this internet electrical business platform.

In accordance with one aspect of the present invention, the feedback money percentage to a member depends on the total headcounts and consuming money of the member's son members.

### BRIEF DESCRIPTION OF THE DRAWINGS

The present invention may best be understood through the following description with reference to the accompanying drawings, in which:

FIG. 1 shows the structure diagram of the internet business transactions approach model system according to the present invention.

### DETAILED DESCRIPTION OF THE PREFERRED EMBODIMENT

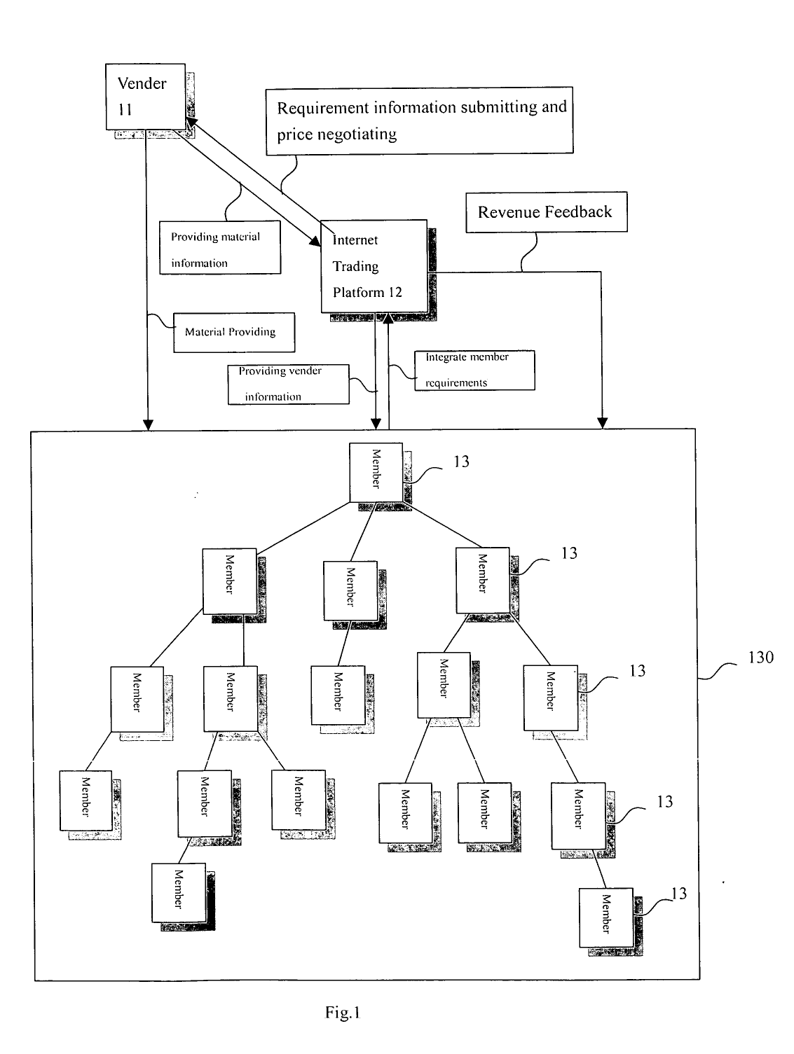

FIG. 1 shows the system block diagram of the internet business transactions approach model system according to the present invention. The internet business transactions approach model system according to the present invention consists of goods venders 11, internet electrical business platform 12, and members 13. Vender 11 is able to provide selling information to members 13 via internet electrical business platform 12, and member 13 is also able to submit purchase requests to the internet electrical business platform 12. Internet electrical business platform 12 will accumulate the purchasing quantity of goods and send to vender 11 for negotiating a reasonable price. Vender 11 will deliver the goods to all the purchasing members based on the members' information that are provided by the internet electrical business platform 12, or this internet electrical business platform 12 will actively lead the purchase request to suitable vender 11 for trading matching after receiving the purchase information from members 13. And this internet electrical business platform 12 will feedback a percentage of revenue to the member 13, in which the percentage of feedback revenue depends on the son member's number of a member 13. Therefore, all the members are able to have a cheaper price of goods, and also be parts of the approach by the system to get more approach feedback money.

In general, the internet business transactions approach model system according to the present invention contains the following major features:

(1) Member structure: Members are generated by Internet log-in, and the other members are commended by the existed members. The above member linkage relations become complex member chains, and these member chains integrate together as the member chain group 130 of the electrical business platform. The advantages of the member structure are:
a. Easy process for creating members by internet log-in;
b. Creating new members by recommended by existed members is able to save the cost of promotion and time.

(2) Internet transaction after accumulating members' information: Electrical business platform will use the trading information interactive accounting interface program (living shopping messenger) to integrate and send purchase order to venders after understanding the goods and quantities or estimated prices by information exchanging of web site and members, to get a best price or to match unique buyer and vender. The advantages of this trading solution are:
a. Easy and direct to understand the required goods quantity and direction in the market;
b. Sharing goods in cheaper prices to all the members directly;
c. Goods venders are able to control delivery quantities more exactly; and
d. Actively connecting the buy and vender, to shorten the survey cost.

(3) Feedback mechanism of approach: Sharing a percentage of trading revenue from the internet business transactions approach model system according to the present invention with members, and the feedback money of every member depends on the total number of his son member chains and their trading revenue. The advantages of this feedback mechanism are:
a. Making a cheaper price by sharing the feedback money to members;
b. Enhancing members' loyalty of this electrical trading platform to be a stable approach;
c. Introducing more members by existed members' recommendations to generate more requirements' quantities for negotiating a cheaper price, and also introducing more venders to join this approach.

The major difference between the present invention and the prior art is, the present invention uses the internet electrical business platform to generate a large database of buyer members, and this internet electrical business platform is able to use trading information interactive accounting interface program (living shopping messenger) to accumulate the requirement information of a member group or even a individual buyer, to match this requirement information with suitable vender, and to negotiate a cheaper price by quantity with vender. Finally the members are able to decide purchasing or not by their own requirements and the goods information. Furthermore, the present invention also provides a revenue feedback mechanism to introduce more and more members.

For example, when the requirement information of a buyer is leading to goods of a vender, which unit price is 1000 dollars, and the unit price will be 900 dollars when the purchasing quantity is larger than 100 pieces, and the unit price will be 800 dollars when the purchasing quantity is larger than 1000 pieces. At this moment, internet electrical business platform 12 will inform all the members to accumulate the total required quantity: if the total required quantity from members is more than 100 pieces, then all the members will have a promotion unit price for 900 dollars; if the total required quantity from members is more than 1000 pieces, then all the members will have a promotion unit price for 800 dollars. Or the required information from buys will be led to match with a vender for a best and reasonable trading price.

And, a percentage of revenue will be feedback to members depends on the number of their recommended son members. By this way, the member number in the member chain group will be increased as a stronger bargain power, and will be easier to get a cheaper price and more goods information from venders.

For preferred means, the member's information enters into the database by logging in and gets unique IDs by system, respectively. Whenever a member logs into the system, he will be requested to enter his ID and system will trace the master-slave relationship of this member by his ID for processing the revenue feedback mechanism.

To sum up, the characteristic of the internet business transactions approach model system according to the present invention is, integrating the member chain group with trading information accounting system and approach feedback mechanism together by internet electrical business platform 12. And the advantage of the present invention is to control the trading information for negotiating a cheaper price, and increasing member's loyalty of approach by revenue feedback mechanism to introduce more and more members and venders.

What is claimed is:

1. An internet business transactions approach model system comprising steps of:
Providing an internet electrical business platform;
Creating a member chain group in master-slave relationship by using said internet electrical business platform;
Generating a trading information accounting system by said member chain group in master-slave relationship; and
Generating a feedback mechanism for said member chain by said member chain group in master-slave relationship.

2. The system according to claim 1 wherein said member chain group in master-slave relationship uses a log-in action to create a new member; said new member is allowed to pull in son members; said member chain group in master-slave relationship is generated by linking to said new members and their son members.

3. The system according to claim 2 wherein said log-in action asks members for entering their personal information and assigns said members respective unique IDs; said IDs are used for master-slave linkage.

4. The system according to claim 1 wherein said trading information accounting system is used for accounting said internet transaction logs of all buyers and venders; by a trading information interactive accounting media program, said system will be able to send goods information to all said members of said member chain group; and said members are also able to send information requests for goods to said internet electrical business platform for integrating said information from buyers and venders; after integrating and accounting said required items and estimated prices of every member, said system will base on a quantities and help to negotiate with goods venders for cheaper prices, or leads one individual buyer to match a suitable venders for a reasonable price, and purchases said order of said goods finally.

5. The system according to claim 1 wherein said feedback mechanism of said member chain is an approach feedback mechanism; said system is able to feedback money to members by a percentage of the revenue from said accounting trading records of this internet electrical business platform.

6. The system according to claim 5 wherein said feedback money percentage to a member depends on said total headcounts and consuming money of said member's son members.
